(19) United States
(12) Patent Application Publication
(10) Pub. No.: US 2015/0097049 A1
(43) Pub. Date: Apr. 9, 2015

(54) Decoupled Needle Control Assembly

(71) Applicant: Erik Jordan Hansen, Ann Arbor, MI (US)

(72) Inventor: Erik Jordan Hansen, Ann Arbor, MI (US)

(73) Assignee: International Engine Intellectual Property Company , LLC, lisle, IL (US)

(21) Appl. No.: 14/046,961

(22) Filed: Oct. 5, 2013

(51) Int. Cl. F02M 63/00

(52) U.S. Cl. CPC F02M 63/0033; F02M 63/0077; F02M 63/0073
USPC 239/96

(57) ABSTRACT

An assembly for a fuel injector that includes a piston that is decoupled from the needle of a needle valve. The piston is slidingly positioned in a disk bore. The portion of needle in the disk bore is smaller than the disk bore so as to prevent the disk bore from interfering with movement of the needle between seated and unseated positions. During periods of operation, the upper surface of the piston is engaged by a control volume of fuel that pushes the needle toward a seated position, while the needle pushes in an opposing direction against a lower surface of the piston. The surface area of the piston acted on by the control volume is larger than the upper portion of the needle that is typically acted upon by the control volume, thereby providing a larger force on the piston that keeps the needle in a seated.

### BACKGROUND

High-pressure fuel injection systems are often used in combustion engines to deliver fuel, such as diesel fuel or gasoline, to a combustion chamber. Fluid is supplied at high-pressure through a common rail to each of a series of unit fuel injectors within the cylinder head. Each injector includes a valve, such as a needle valve, which controls the release of fuel from the fuel injector. When the needle valve is in an open or unseated position, fuel is forced out of a small outlet in a nozzle assembly of the fuel injector under high pressure, thereby typically atomizing the fuel that is delivered to the combustion chamber of the combustion engine.

Fuel injectors typically utilize the needle valve to inject fuel from the fuel injector into the combustion chamber. The needle valve includes a needle that moves between open and closed positions based on differences in the various pressures that may be acting upon the needle, and more specifically, differences in the surface area of the needle that is exposed to such pressures. When the needle moves from a closed position, where the needle is seated on a valve seat, to an open position, where the needle is no longer seated on the valve seat, the fuel pressure forces fuel through the outlet of the nozzle assembly and into the combustion chamber. When the injection of fuel from the fuel injector is to be terminated, the needle is returned to its normally closed position, and fluid may flow from a common rail to refill the pressurization chamber.

When pressurized fuel that will be injected into the combustion chamber is supplied to a nozzle chamber of the injector, the pressurized fuel may act against the needle in a direction that attempts to push the needle to an open position. To at least counteract such forces from the pressurized fuel, fuel injectors that allow for active control of the needle typically include an area above the needle where a quantity of pressurized fuel, or a control volume of fuel, is allowed to accumulate. This control volume may provide a force against an upper surface of the needle that at least assists in counteracting the force from the pressurized fuel on the needle in the nozzle chamber so that the needle valve remains in a closed position. When these pressures from the control volume and fuel in the nozzle chamber are generally equal, the needle may be biased to a closed position by a needle spring. The needle spring may also be configured to overcome pressures created in the ignition chamber when the engine is initially being cranked during start-up, as well as to increase the speed at which the needle moves from the open position to the closed position.

When fuel in the nozzle chamber of an injector that utilizes active needle control is to be injected into the combustion chamber, the control volume may be drained or otherwise removed. The draining of the control volume removes the pressure or forces that were counteracting the pressure being exerted on the needle by fuel in the nozzle chamber. The removal or reduction of the pressure that had been provided by the control volume allows the fuel pressure in the nozzle chamber to force the needle to move from the closed position to the open position, thereby allowing fuel to be injected into the combustion chamber. When the injection of fuel is terminated, the needle valve may again be closed, such as, for example, by replenishing the control volume above the needle valve as well as by the biasing force of the spring.

The required movement of the needle valve between open and closed positions may present alignment and sealing issues. For example, the upper portion of the needle that is adjacent to the control volume may need to be sized to provide a seal that prevents fuel from the control volume from leaking into the nozzle chamber, and vice versa. Such a seal may interfere with the ability of the needle to rapidly move between seated and unseat positions, and vice versa. Further, such a seal may require tight manufacturing tolerances. Additionally, while the upper end of the needle may act as a seal for the control volume, the lower end continues to act as a seal that prevents the premature release of fuel out of the fuel injector. Accordingly, the needle valve and/or surrounding components may be manufactured to tight, and expensive, tolerances, so as to prevent misalignment at either end of the needle that may result in undesirable fuel leaks out from, or in, the fuel injector.

### SUMMARY

An aspect of the illustrated embodiment is an assembly for a fuel injector that includes a needle valve having a needle. The needle includes an upper portion and a tip region. The tip region is configured to be seated against a valve seat of the fuel injector when the needle valve is in a seated position. The assembly also includes a disk having a disk bore and a chamber. The disk bore is configured to receive the insertion of at least a portion of the needle. The chamber is configured to receive a control volume of fuel. Additionally, the chamber being in fluid communication with the disk bore. The assembly further includes a piston having an upper surface, a lower surface, and a wall. The piston is slideably disposed in the disk bore. Further, the upper surface of the piston has a surface area that is configured to be exposed to the control volume of fuel in the chamber that is larger than a surface area of the upper portion of the needle that is typically exposed to the control volume of fuel. This increase in surface area that is exposed to the control volume fuel allows for an increase in the downward force exerted on the needle.

Another aspect of the illustrated embodiment is an assembly for a fuel injector that includes a nozzle body having a valve seat, a longitudinal bore, and a nozzle chamber. The longitudinal bore is in fluid communication with a nozzle chamber. The assembly also includes a needle having a tip region and an upper portion. The needle is configured to be displaced from a seated position, in which the tip region is seated against the valve seat, to an unseated position. The assembly also includes, a needle collar having a bore, an upper surface, and an outer wall. The bore is configured to receive the slidable insertion of at least a portion of the needle. Additionally, the assembly includes a disk having a disk bore, a weep hole, and a chamber. The chamber is configured to receive a control volume of fuel. The disk bore is configured to receive the insertion of at least a portion of the needle. The disk bore has a diameter larger than the diameter of the portion of the needle received in the disk bore. The assembly further includes a piston having a top surface, a lower surface, and a wall. The piston has a diameter larger than the diameter of the upper portion of the needle. The upper surface of the piston is positioned to be engaged by at least a portion of the control volume of fuel in the chamber.

A further aspect of the illustrated embodiment is an assembly for a fuel injector that includes a disk having a disk bore and a chamber. The chamber is configured to receive a control volume of fuel. The assembly also includes a piston that is configured for slidable movement along at least a portion of the disk bore. An upper surface of the piston is configured to be engaged by at least a portion of the control volume of fuel in the chamber. The assembly also includes a nozzle body having a nozzle chamber. At least a portion of the nozzle body abuts a lower surface of the disk. The assembly further includes a needle having a tip region and an upper portion. The needle is configured to be moved between a seated position and an unseated position in the nozzle body. The upper portion of the needle has a smaller surface area than the upper surface of the piston. The upper portion is configured to be engaged by a lower surface of the piston in the disk bore when the needle is in a seated position.

### BRIEF DESCRIPTION OF THE DRAWINGS

FIG. 1 illustrates a cross sectional view of a nozzle portion for a high pressure fuel injector that has a detached piston and needle.

FIG. 2 illustrates a cross sectional view of the nozzle portion shown in FIG. 1 and where the disk includes a body portion and a plate.

### DETAILED DESCRIPTION

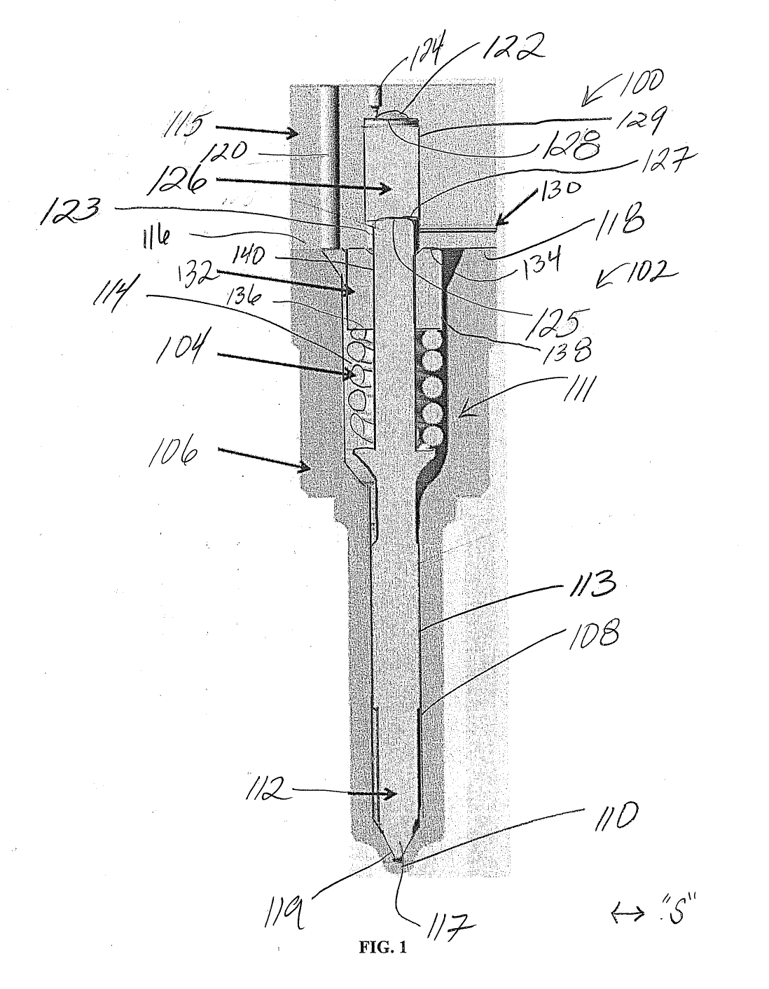

FIG. 1 illustrates a cross sectional view of a portion of a high pressure fuel injector 100. High-pressure fuel injectors 100 generally include a nozzle section 102. The nozzle section 102 includes a nozzle spring 104 and a nozzle body 106. The nozzle body 106 includes a longitudinal bore 108 that terminates in a nozzle orifice 110. A nozzle valve, such as a needle valve 111, is configured so that a portion of the needle 112 of the needle valve 111 is slideably disposed in the longitudinal bore 108. The needle 112 is configured to be moved in the nozzle body 106 between a closed (seated) position that prevents fuel from being release through the orifice 110, and an open (unseated) position that allows fuel in the nozzle chamber 114 to be released through the orifice 110 and into a combustion chamber of the engine. When in the seated position, at least a portion of a tip region 117 of the needle 112 may abut a valve seat 119 in the nozzle body 106. Additionally, the nozzle spring 104 is configured to bias the needle 112 in the seated position.

The longitudinal bore 108 of the nozzle body 106 may be configured to guide the movement of the needle 112 as the needle 112 moves between the unseated and seated positions. In order to prevent the longitudinal bore 108 from interfering with such movement of the needle 112, the longitudinal bore 108 may be larger than the outer dimension of the adjacent portion of the needle 112 so as to provide clearance between the longitudinal bore 108 and the adjacent portion of the needle 112. For example, if the needle 112 is generally cylindrical in configuration, the longitudinal bore 108 may have a diameter that is slightly larger than the adjacent outer diameter of the needle 112.

According to certain embodiments, the needle 112 may include a needle guide 113. The needle guide 113 may be a portion of the needle 112 in the longitudinal bore 108 that has an increased size so as to further assist with the alignment of the tip region 117 of the needle 112 and the valve seat 119. However, again, the needle guide 113 may also be sized so that an interference is not created between the needle guide 113 and the wall of the longitudinal bore 108 when the needle 112 is displaced between unseated and seated positions. Additionally, the needle guide 113 may include grooves or flats that allow fuel to flow past the needle guide 113 and to the orifice 110 of the nozzle body 106.

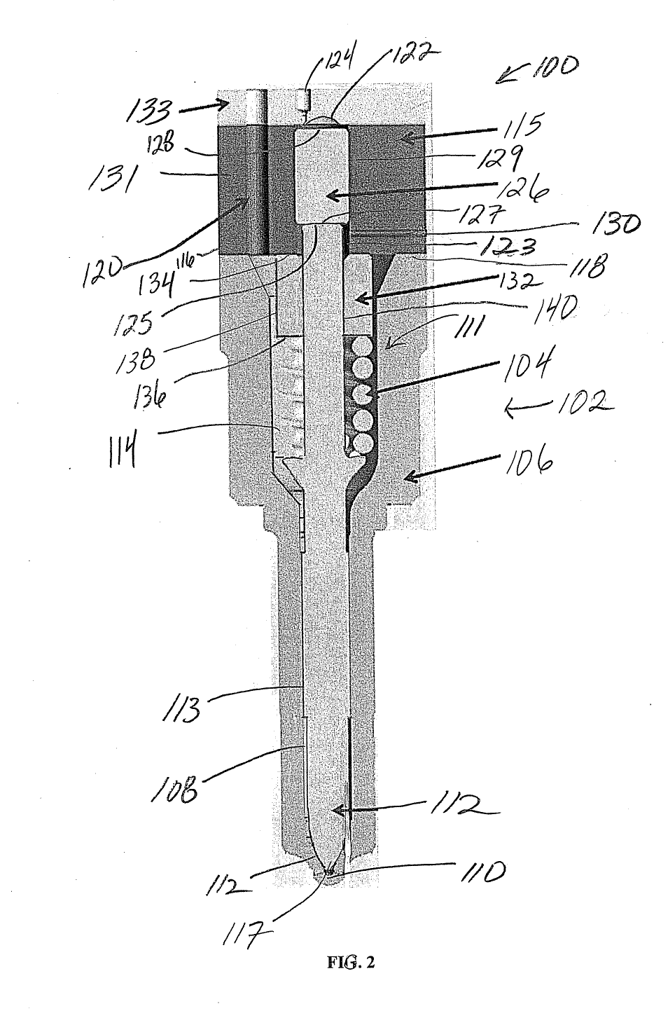

The high pressure fuel injector also includes a disk 115 that is adjacent to an upper portion 118 of the nozzle body 106. The disk 112 includes a chamber 122, a disk bore 123, a lower portion 116, and a weep hole 130. The disk 115 and nozzle body 106 may be adjoined to provide a seal that prevents or minimizes the leakage of fuel between the lower portion 116 of the disk 115 and the upper portion 118 of the nozzle body 106. The disk 115 may also include, or be operably connected to, a fuel inlet line 120 that is used to deliver fuel to the nozzle body 106, and more specifically, to the nozzle chamber 114. As shown in FIG. 2, according to certain embodiments, the disk 115 may include a body portion 131 and a plate 133 that are joined together to provide a seal that prevents, or minimizes, the flow of fuel there between. Use of a separate body portion 131 and plate portion 133 may allow the disk bore 123 to be manufactured as a through hole in the body portion 131, while the plate 133 may be manufactured to include at least a portion of the chamber 122, and, if desired, a portion of the disk bore 123.

The chamber 122 is configured to receive a control volume of fuel. The chamber 122 may receive fuel used for the control volume through a control fuel line 124. According to certain embodiments, the control fuel line 124 may also be used to evacuate the control volume of fuel from the chamber 122 when the needle 112 is to be moved to an unseated position. For example, the control fuel line 124 maybe in fluid communication with a three-way valve that uses the same control fuel line 124 to the supply and drain of the control volume of fuel into/out of the chamber 122. However, according to other embodiments, the disk 115 may include a separate exhaust line through which fuel used for the control volume may be removed or exhausted from the chamber 122. For example, according to certain embodiments, a two-way valve may be employed for the supply of the control volume of fuel through the control fuel line 124 to the chamber 122, while a separate exhaust line in the disk 123 drains the control volume of fuel from the chamber 122.

The weep hole 130 is in communication with the bore 123 of the disk 115. The weep hole 130 may provide a pathway for the removal of fuel that has entered into the bore 123, such as, for example, fuel from the nozzle chamber 114 and/or the chamber 122. Moreover, the weep hole 130 may prevent the accumulation of fuel in the bore 123 of the disk 115 that may interfere with the movement of the piston 126 and/or needle 112. Further, the weep hole 130 may terminate in an area of lower pressure than the pressure in the bore 123 so as to draw fuel out of the bore 123.

The chamber 122 may be in fluid communication with the disk bore 123 such that fuel used for the control volume may exert a force on a top surface 128 of a piston 126 that is at least partially located in the disk bore 123. The piston 126 includes the top surface 128, a lower surface 127, and a wall 129. The piston 126 is configured to be slidingly displaced along the disk bore 123. The piston 126 is also configured so that the wall 129 of the piston 126 provides a seal in the disk bore 123 that is intended to prevent, or minimize, the flow of fuel from the control volume into areas beneath the piston 126 and/or between the wall 129 of the piston and the disk bore 123. During operation of the fuel injector 100, the lower surface 127 of the piston 126 may normally be in contact with a top surface 128 of the needle 112.

As shown in FIG. 1, the piston 126 has a diameter that is larger than the portion of the upper portion 125 of the needle 112 that abuts the lower surface 127 of the piston 126 during operation of the injector 100. The smaller size of the upper portion 125 of the needle 112 may prevent the needle 112 from contacting the wall of the disk bore 123. For example, according to certain embodiments, there is a clearance size or diameter between the adjacent surfaces of needle 112 and the disk bore 123 that is greater than the maximum amount the needle 112 may move in the “S” direction (as shown in FIG. 1) plus the amount the needle 112 may be deflected during operation of the injector 100. The lack of contact between the needle 112 and the disk bore 123 provided by such a clearance may prevent interference between the needle 112 and the disk bore 123 that may otherwise interfere with the movement of the needle 112 as the needle 112 is displaced between seated and unseated positions, and vice versa. Additionally, such lack of contact between the needle 112 and the disk bore 123 may remove a cause for potential misalignment between the needle 112 and the valve seat 119.

When compared to designs in which the control volume acts upon the upper portion 125 of the needle 112, the top surface 128 of the piston 126 provides a larger surface area upon which the control volume may exert pressure on the piston 126. This larger surface area allows the piston 126 to exert a larger downward force against the needle 112 than is typically experienced with needle valves in which the control volume of fuel exerts a force directly on the smaller upper portion of the needle 112. This larger force provided by the larger surface area of the top surface 128 of the piston 126 that is exposed to the control volume may allow for an increase in the speed at which the needle 112 may be moved from an open position to a closed position. Further, this increase force may also allow for a reduction in the size of the biasing force of the nozzle spring 104, which may in turn allow for faster times when the needle 112 moves from the closed position to the open position.

According to certain embodiments, the fuel injector 100 also includes a needle collar 132. The needle collar 132 may include an upper surface 134, a lower surface 136, an outer wall 138, and a bore 140. The bore 140 may be slight larger than the outer diameter of the adjacent portion of the needle 112 so as to provide a match fit that prevents the needle collar 132 from interfering with the displacement of the needle 112 between the seated and unseated positions, while also providing a seal the prevents, or minimizes the amount of, pressurized fuel entering into the area between the bore 140 and needle 112. Further, the upper surface 134 of the needle collar 132 may abut the lower portion 116 of the disk 115 so as to form a seal that prevents or minimizes the presence or entry of pressurized fuel between the needle collar 132 and the disk 115. For example, as pressurized fuel acts against the lower surface 136 of the needle collar 132, the resulting pressure differential between the upper 134 and lower surfaces 136 of the collar 132 presses the upper surface 134 of the collar 132 against the lower portion 116 of the disk 115 to form a seal there-between. The formation of this seal may also be aided by an additional force provided by the nozzle spring 104 that also presses the needle collar 132 against the lower portion 116 of the disk 115.

During use, a control volume of fuel is provided to the chamber 122 through the control fuel line 122. The pressurized control volume exerts a force across the top surface 128 of the piston 126 that presses the piston 126 against the upper portion 125 of the needle 112 in a direction that generally pushes the needle 112 toward the seated or closed position.

The nozzle chamber 114 may be filled with pressurized fuel that is to be injected into the combustion chamber. The pressurized fuel in the nozzle chamber 114 may be at approximately the same pressure as the pressure of the control volume of fuel. The pressurized fuel in the nozzle chamber 114 may exert a force that attempts to move the needle 112 from a seated position to an unseated position. Accordingly, the upper portion 125 of the needle 112 may assert a force against the lower surface 127 of the piston 126. However, as previously discussed, as the pressure of the control volume of fuel in the chamber 122 and the fuel pressure in the nozzle chamber 114 are approximately the same, the pressure across the larger surface area of the top surface 128 of the piston 126 results in a greater force being exerted across the top portion of the piston 126 than the force provided by the smaller upper portion 125 of the needle 112 pressing against the lower surface 127 of the piston 126. Moreover, the force associated with the pressure of the control volume on the piston 126 may allow the piston 126 to continue to exert a force that pushes the needle 112 toward the seated position. Additionally, the nozzle spring 104 may also provide a force that assists the control volume in retaining the needle 112 in a seated position.

When fuel is to be injected from the nozzle chamber 114 and into the combustion chamber, the control volume of fuel may be drained or exhausted from the chamber 122. The fuel pressure in the nozzle chamber 114 may then act against the needle 112 to force the needle 112 upwardly against the force of the nozzle spring 104 and the piston 126. Additionally, as the needle 112 is not coupled to the piston 126 and the needle 112 is smaller in width or diameter than the bore 123 of the disk 115, the needle 112 may avoid potential issues associated with the interference between the needle 112 and the disk bore 123. For example, elimination of such interference may reduce or eliminate the potential for incomplete lift of the needle 112 when the needle 112 is moved to the open position, with incomplete lift being associated with reduce delivery of fuel to the combustion chamber, and binding of the needle 112, which may otherwise cause erratic fuel injection. When the needle 112 is unseated from the valve seat 119, and moreover the nozzle orifice 110, fuel passes through the nozzle orifice 110 and is delivered to the associated engine combustion chamber.

When the injection process is to be terminated, a control volume of fuel may again be provided to the chamber 122. This control volume may again exert a force on the top surface 128 of the piston 126 that may press the piston against the upper portion 125 of the needle 112. Again, the control volume of fuel is acting across a surface area of the piston 126, namely the top surface 128, that is larger than the surface area of the upper portion 125 of the needle 112 that the control volume typically operates upon. Accordingly, the force exerted against the piston 126 by the control volume that is pushing the needle 112 toward the seated position is enhanced so as to be able to overcome the opposing force against the piston 126 by the needle 112. Further, the nozzle spring 104 may also be biasing the needle 112 to the closed position. Accordingly, the forces of the piston 126 that is decoupled from the needle 112 in connection with the biasing force of the nozzle spring 104 may allow for faster closing of an opened needle valve 111 to be obtained without the need for increasing the size of the needle spring 104.

1. An assembly for a fuel injector comprising:
a needle valve having a needle, the needle having an upper portion and a tip region, the tip region configured to be seated against a valve seat of the fuel injector when the needle valve is in a seated position;
a disk having a disk bore and a chamber, the disk bore configured to receive the insertion of at least a portion of the needle, the chamber configured to receive a control volume of fuel, the chamber being in fluid communication with the disk bore; and
a piston having an upper surface, a lower surface, and a wall, the piston slideably disposed in the disk bore, the upper surface of the piston having a surface area that is configured to be exposed to the control volume of fuel in the chamber that is larger than a surface area of the upper portion of the needle, the lower surface of the piston being configured to be engaged by the upper portion of the needle.

2. The assembly of claim 1, wherein the upper portion of the needle has a width that is smaller than the disk bore so as to prevent the upper portion of the needle from contacting a wall of the disk bore.

3. The assembly of claim 2, further including a needle collar having an upper surface, a lower surface, an outer wall, and a bore, the bore of the needle collar being configured to receive the slidable displacement of at least a portion of the needle, the upper surface of the needle collar is configured to abut the disk to provide a seal that is configured to prevent fuel from passing between the upper surface of the needle collar and a lower portion of the disk.

4. The assembly of claim 3, wherein the disk has a body portion and a plate, the body portion including at least a portion of the disk bore, the plate having at least the chamber of the disk.

5. The assembly of claim 2, wherein the disk includes a weep hole that is in fluid communication with the disk bore and a lower pressure area, the weep hole being configured to remove fuel from an area of the disk bore between the lower surface of the piston and the upper surface of the needle collar.

6. An assembly for a fuel injector comprising:
a nozzle body having a valve seat, a longitudinal bore, and a nozzle chamber, the longitudinal bore being in fluid communication with a nozzle chamber;
a needle having a tip region and an upper portion, the needle being configured to be displaced from a seated position, in which the tip region is seated against the valve seat, to an unseated position;
a needle collar having a bore, an upper surface, and an outer wall, the bore configured to receive the slidable insertion of at least a portion of the needle;
a disk having a disk bore, a weep hole, and a chamber, the chamber configured to receive a control volume of fuel, the disk bore configured to receive the insertion of at least a portion of the needle, the disk bore having a diameter larger than the diameter of the portion of the needle received in the disk bore; and
a piston having a top surface, a lower surface, and a wall, the piston having a diameter larger than the diameter of the upper portion of the needle, the upper surface of the piston positioned to be engaged by at least a portion of the control volume of fuel in the chamber, the lower surface of the piston configured to be engaged by the upper portion of the needle.

7. The assembly of claim 6, wherein the weep hole is configured to remove fuel present in the disk bore from an area between the lower surface of the piston and the upper surface of the needle collar.

8. The assembly of claim 6, wherein the upper surface of the needle collar is configured to abut the disk to provide a seal that is configured to prevent fuel from passing between the upper surface of the needle collar and a lower portion of the disk.

9. The assembly of claim 6, wherein the bore of the needle collar is configured to provide a seal that minimizes the amount of fuel from the nozzle chamber that enters an area between the bore of the needle collar and an adjacent portion of the needle.

10. The assembly of claim 9, wherein the piston is sized to provide a seal with the disk bore that at least minimizes the amount of the control volume of fluid that passes into an area between the lower surface of the piston and the upper surface of the needle collar.

11. The assembly of claim 6, wherein the disk has a body portion and a plate, the body portion including at least a portion of the disk bore, the plate having at least the chamber of the disk.

12. An assembly for a fuel injector comprising:
a disk having a disk bore and a chamber, the chamber configured to receive a control volume of fuel;
a piston configured for slidable movement along at least a portion of the disk bore, an upper surface of the piston configured to be engaged by at least a portion of the control volume of fuel in the chamber;
a nozzle body having a nozzle chamber, at least a portion of the nozzle body abuts a lower surface of the disk; and
a needle having a tip region and an upper portion, the needle configured to be moved between a seated position and an unseated position in the nozzle body, the upper portion of the needle having a smaller surface area than the upper surface of the piston, the upper portion configured to be engaged by a lower surface of the piston in the disk bore at least when the needle is in a seated position.

13. The assembly of claim 12, wherein the upper portion of the needle has a width that is smaller than the disk bore so as to prevent the upper portion of the needle from contacting a wall of the disk bore.

14. The assembly of claim 12, further including a needle collar having an upper surface, a lower surface, an outer wall, and a bore, the bore of the needle collar being configured to receive the slidable displacement of at least a portion of the needle, the upper surface of the needle collar being configured to abut the disk to provide a seal that is configured to prevent fuel from passing between the upper surface of the needle collar and a lower portion of the disk.

15. The assembly of claim 14, wherein the disk includes a weep hole that is in fluid communication with the disk bore and a low pressure area, the weep hole being configured to remove fuel present in the disk bore from an area between the lower surface of the piston and the upper surface of the needle collar.
